(19) United States
(12) Patent Application Publication
(10) Pub. No.: US 2014/0172690 A1
(43) Pub. Date: Jun. 19, 2014

(54) Systems and Methods For Matching Domain Specific Transactions

(71) Applicant: SAS Institute Inc., Cary, NC (US)

(72) Inventors: Brian Duke, Poway, CA (US); Revathi Subramanian, San Diego, CA (US); Paul C. Dulany, San Diego, CA (US)

(21) Appl. No.: 13/717,531

(22) Filed: Dec. 17, 2012

(51) Int. Cl. G06Q 20/40

(52) U.S. Cl. CPC G06Q 20/4016
USPC 705/39

(57) ABSTRACT

Systems and methods for matching domain-specific transactions are provided. Some of the disclosed systems and methods can include receiving, on a computing device, transaction data associated with an entity, retrieving signature data associated with the entity, wherein the signature data includes historic data associated with the entity; updating the signature data to include the transaction data, wherein updating includes using a model, and generating a score for the transaction data using the updated signature data and the model. The disclosed system and method further includes receiving new transaction data associated with the entity; retrieving the updated signature data associated with the entity; determining whether the transaction data and the new transaction data are related, and if so, updating the transaction data with the new transaction data, and generating a score for the updated transaction data using the updated signature data and the model.

### TECHNICAL FIELD

The present disclosure relates generally to computer-implemented systems and methods for processing transactions and more specifically to matching domain-specific transactions.

### BACKGROUND

Some transactions, such as credit card purchases, can create multiple records for each transaction as part of the authorization process.

### SUMMARY

In accordance with the teachings provided herein, systems and methods for matching domain-specific transactions are provided. For example, one described method includes receiving, on a computing device, transaction data associated with an entity; retrieving signature data associated with the entity, wherein the signature data includes historic data associated with the entity; updating the signature data to include the transaction data, wherein updating includes using a model, and generating a score for the transaction data using the updated signature data and the model. The method further includes receiving new transaction data associated with the entity; retrieving the updated signature data associated with the entity; determining whether the transaction data and the new transaction data are related, and if so, updating the transaction data with the new transaction data; and generating a score for the updated transaction data using the updated signature data and the model.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

The utility of the embodiments of the invention will be readily appreciated and understood from consideration of the following description of the embodiments of the invention when viewed in connection with the accompanying drawings.

FIG. 1 shows a block diagram of an example of a system 100 for matching domain-specific transactions;

FIG. 2 is a flow chart illustrating an example of a process for accepting a first transaction request from a device, such as gas pump 110;

FIG. 3 is a flow chart, illustrating an example of a process implemented by the gas pump 110 once the transaction illustrated in FIG. 2 is complete;

FIG. 4 is a flow chart showing an example of a process implemented by the payment processing system 130 upon receiving a transaction; and

FIGS. 5A and 5B are tables showing data used for the signature with and without implementation of an example of a process for matching the first and second transactions.

Like reference numbers and designations in the various drawings may indicate like elements.

### DETAILED DESCRIPTION

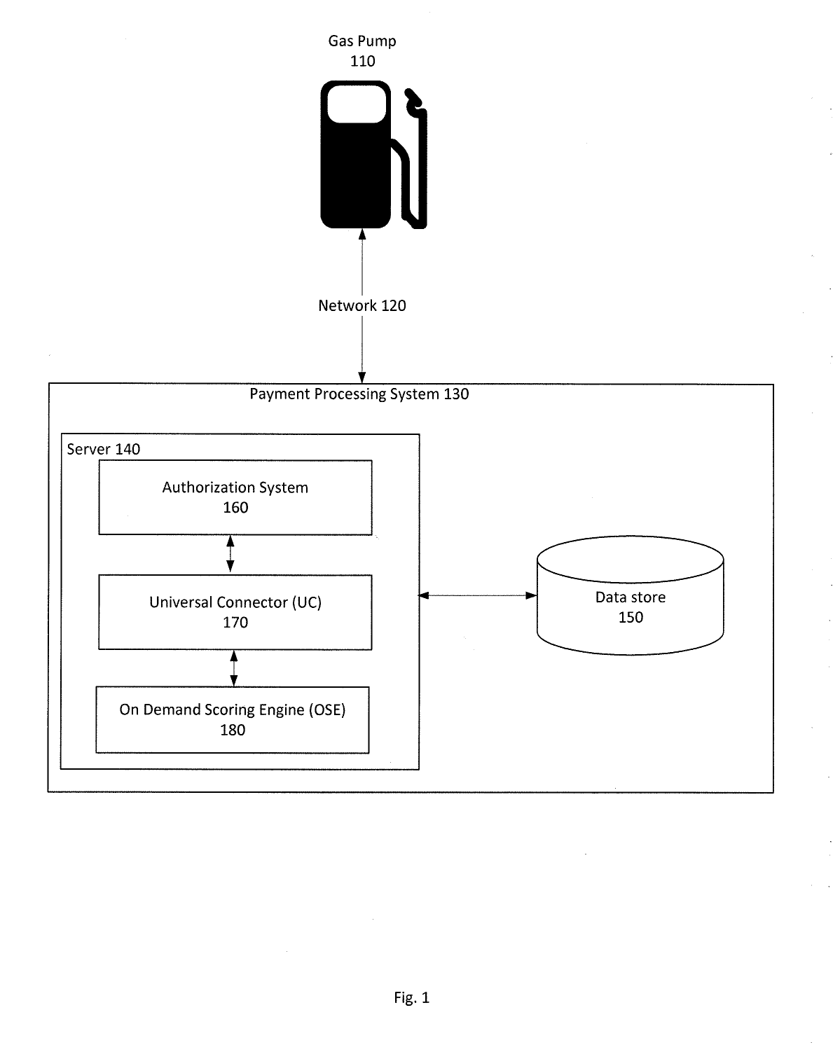

FIG. 1 shows a block diagram of an example system 100 for matching domain-specific transactions. System 100 is a computer-implemented environment wherein one or more users interact with a point-of-sale terminal or other device, such as a gas pump 110. The gas pump 110 shown includes software executing on a processor and one or more communications interfaces that enable the software on gas pump 110 to communicate over a network 120 with a payment processing system 130.

The payment processing system includes one or more servers, such as server 140. While a single server 140 is shown, some embodiments may include multiple servers. The servers may be virtual or physical servers and may be located in geographically disparate locations. The server 140 includes software which implements operations or routines for matching domain-specific transactions. The software includes software for receiving transactions from various sources, such as gas pump 110 and other point-of-sale devices or any devices that provide multiple related transactions. The software also includes software for analyzing the transactions to determine whether any of the individual transactions is related to or “matches” another transaction as described herein.

In the embodiment shown, the server 140 is in communication with a data store 150. Examples of data store(s) 150 can include relational database management systems (RDBMS), a multi-dimensional database (MDDB), such as an Online Analytical Processing (OLAP) database, or an in-memory database (IMDB). The description of the example system 100 shown in FIG. 1 is merely illustrative, and the Figures below are described in relation to system 100 merely for clarity. The data store 150 stores data in a raw form. For example, the data store 150 may store all of the raw data for the last 15-20 transactions for a particular account to enable processing according to one or more embodiments.

The server 140 includes various software components, including an authorization system 160. The authorization system 160 receives a transaction, retrieves data from and stores data in the data store 150, and communicates with a universal connector (UC) 170. In the embodiment shown, the authorization system 160 and UC 170 are shown to be on the same server. However, in some embodiments, the authorization system 160 and UC 170 are present on separate servers and may be present in separate geographic locations. They also each may access a different data store 150. The UC 170 acts as an interface that connects various other components of an embodiment with authorization system 160 and other processing systems that may be present on the server 140 or on other servers. In the embodiment shown, transactions, such as purchases flow from the authorization system 160 to the UC 170, where they are prepared by appending the appropriate data based on the transaction type. The data may contain information, such as user and system variables, and will vary depending on transaction type.

The embodiment in FIG. 1 also includes an On-Demand Scoring Engine (OSE) 180. The OSE 180 is in communication with the UC 170, and together, they control the use of models and the execution of both user-written and system rules. The UC 170 submits the transaction to the scoring engine 180, which then executes the appropriate models to automatically and dynamically produce a score, as well as executing the associated decision logic or rules as specified by the developer of the system.

The OSE 180 allows the use of public signature entities (e.g., account, customer, IP, etc.) that are under the complete control of the developer of the system. Additional fields that may be used as part of a signature include the card number, account number, merchant number, and transaction type. Other fields may be used as well.

A signature record may be retrieved from the data store 160 by deriving features from the raw data. For example, a signature may be an account-level compilation of historic data of all transaction types. Signatures help a model to recognize behavior change (e.g., to detect a trend and deviation from a trend). In one embodiment, one record is stored for each account. Signature data may be updated with every new transaction. The signature includes one or more fields, and those fields may be used as data variables by a model.

Such embodiments utilize raw data to monitor each transaction, allowing the system to capture customer behavior patterns from a variety of sources and evaluate the information each time a transaction is scored. The raw data is scored by a model, such as a neural network model. Such a model may use an adaptive segmentation scheme that evolves during the model building process based on the ability of the neural networks to detect changes in transaction attributes.

One of skill in the art will appreciate that various embodiments may be implemented using various alternative architectures.

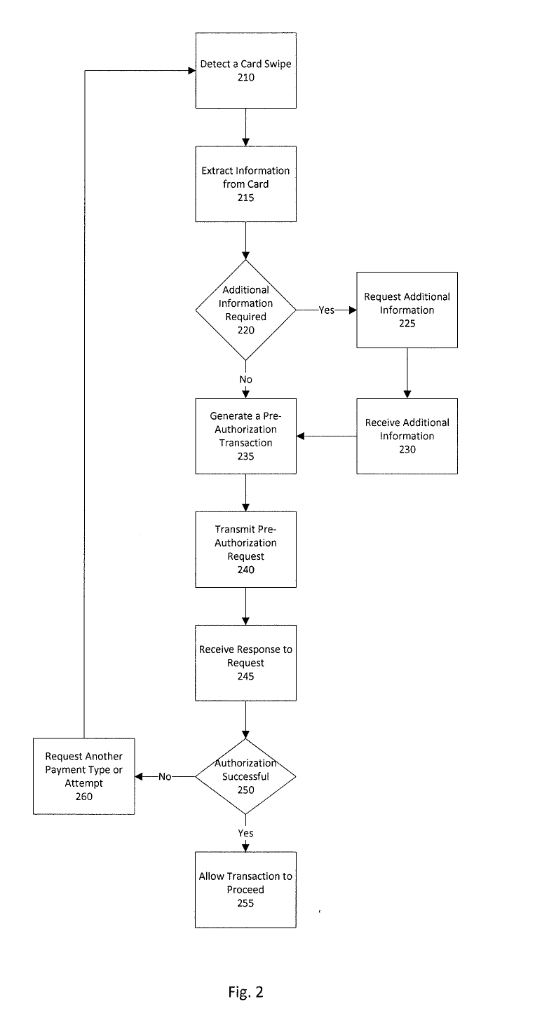

FIG. 2 is a flow chart illustrating an example of a process for accepting a first transaction request from a device, such as gas pump 110. To begin a transaction, gas pump 110 and other types of devices used at points of sale include card readers, keypads, and/or other devices for accepting input from a user. Such devices may include magnetic readers, short-range radio communication interfaces, such as Bluetooth, optical readers, such as bar code scanners, and the like. Any such device capable of reading information from the customer's card or device or otherwise accepting user input may be utilized in some embodiments. In the embodiment shown, the gas pump 110 includes a card reader and begins the process by detecting a card swipe 210 using a magnetic card reader.

The processor in the gas pump 110 receives an information record from the card reader and extracts the relevant information from the data 215. For example, the processor may extract the name, credit card number or other identifier, and expiration date from the data provided by the reader.

The gas pump 110 next determines whether additional information is required 220. If such information is required, the gas pump 110 requests the additional information 225. For example, for a credit card transaction, the gas pump 110 may request that the user enter a billing zip code number. For a debit card, the gas pump may request that the user enter a personal identification number (“PIN”). The gas pump 110 then receives the information 230.

In the embodiment shown in FIG. 1, once the gas pump 110 has all of the information required to create a transaction, the gas pump 110 generates a pre-authorization transaction 235. A preauthorization transaction may also be referred to as a card authorization or authorization hold. The amount of the preauthorization transaction is “held” and unavailable to the card holder until either the merchant settles or clears the transaction or the hold expires. The hold typically expires after several days but can last as long as 30 days. The settlement process is described in further detail below. The amount of the preauthorization transaction may be related or unrelated to the projected amount of the transaction. For example, the transaction amount may be set to $1 and used as a confirmation that the card is valid. Alternatively, the preauthorization may be for an amount that is equal to or based on the projected cost of the completed transaction. For example, a rental car company may preauthorize the projected rental fees plus a percentage or fixed dollar amount for incidentals, such as fuel service. When the car is returned, the rental car company will determine the actual charges for the rental as described below.

The preauthorization request includes data. For example, the preauthorization requests may include a timestamp. The preauthorization request also may identify the merchant and the card used for payment along with a payment amount. Additional information may also be included in the transaction.

The gas pump 110 then transmits the pre-authorization request to the payment processing system 130 over the network 120. In some embodiments, the network 120 may include the internet. While the network 120 is illustrated by a link between the gas pump 110 and the network 120, the network 120 likely includes several different entities. For instance, in one embodiment, the transaction is sent from the merchant to a point-of-sale service that accepts transactions and then forwards them to an aggregator. The aggregator in turn sends the transactions to a credit card network, which then forwards the transactions to the bank that issued the credit card. This flow is meant to be illustrative and other data flows and architectures may be utilized by various embodiments. In addition to the information provided by the user, the gas pump 110 may include additional information. For example, a merchant identifier, date, and time may be added to the customer's information as part of the transaction.

Once the transmission has been sent, the gas pump waits for a response. In some embodiments, if a response is not received within some period of time, the gas pump 110 may resend the transaction. This can result in multiple pre-authorization transactions being received by the server 140 in the payment processing system 130.

In the embodiment shown in FIG. 2, the gas pump 110 next receives a response to the request 245. The response will indicate whether the authorization was successful 250.

If the request is successful, the gas pump 110 will allow the transaction to proceed 255. For example, the customer will be allowed to pump gas into the car, or the customer will be allowed to leave in the rental car. If the transaction is not successful, the gas pump requests another payment type or attempt with the same card 260. The transaction may fail for any number of reasons, such as exceeding a credit limit or the zip code or PIN not matching information stored in the data store 150 for that particular card. The data store 150 includes raw data. In some embodiments, raw data may not be summarized. By storing raw data, the data store 150 can make comparisons among the data that would be difficult or potentially impossible with summarized data.

Once the transaction has been approved to proceed, the customer completes the transaction. For example, in the embodiment shown, once the preauthorization process shown in FIG. 1 is complete, the customer uses the gas pump 110 to put gas in an automobile. In other examples described herein, the customer is able to use a rental car or hotel room. In some embodiments, the customer is able to add a tip to a payment for food.

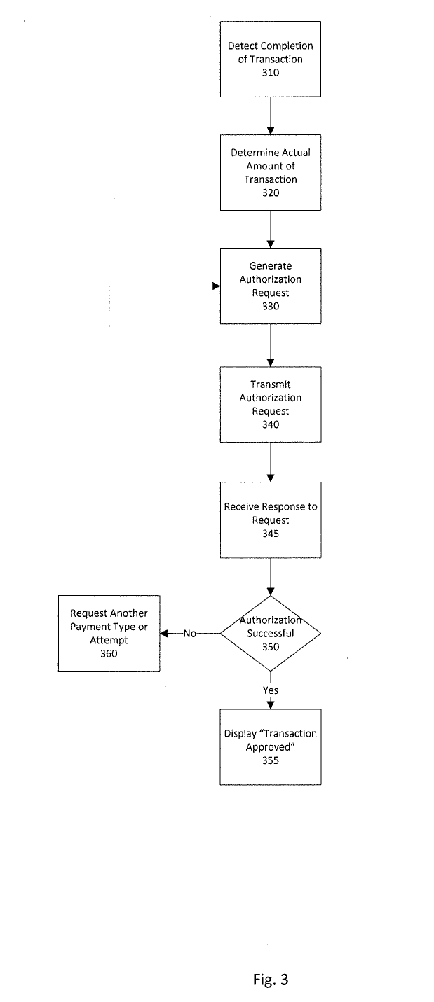

FIG. 3 is a flow chart, illustrating an example of the process implemented by the gas pump 110 once the transaction is complete. In the embodiment shown in FIG. 3, once the transaction is complete, the gas pump 110 detects the completion of the transaction 310. For example, when the customer finishes pumping gas into the car, the customer places the gasoline handle back in the gas pump 110, triggering transaction completion.

Once the transaction is complete, the gas pump 110 determines the actual amount of the transaction 320. Merchants, such as gas stations, restaurants, hotels and car rental companies all may settle a transaction for an amount that differs from the original preauthorization amount. This may be due to the unpredictability of the final transaction amount. For example, the gas pump 110 can track the amount of gas pumped and the price per gallon. Oftentimes, such merchants may add a percentage or fixed dollar amount above the estimate charge for a product or service as described above. The merchant may not settle the amount until the transaction, rental, or stay has been completed. Such transactions may also occur in the context of a currency exchange. Since the exchange rate can change, the transaction amount may typically be based on the exchange rate in effect at the time of settlement, which may not be known at the time the transaction is authorized.

For a rental car agency, for example, when the automobile is returned the actual price of the rental is calculated and provided to the customer. In another example, in the case of a restaurant, once the customer receives the preauthorized statement, the customer can add a tip to the amount. The server then returns to the credit card processing device and enters the complete amount, including the tip.

Once the gas pump 110 has determined the actual amount, the gas pump generates an authorization request for the actual amount 330. This transaction may be referred to as a settlement. The transaction may be transmitted as an advice transaction, signifying that it's related to an earlier transaction. The gas pump 110 then waits for a response to the request. In some cases, the gas pump 110 may not send a second transaction. For example, the transaction may be cancelled by the user. In other cases, additional transaction may be sent, for instance, when a response to the initial request is not received within a set amount of time.

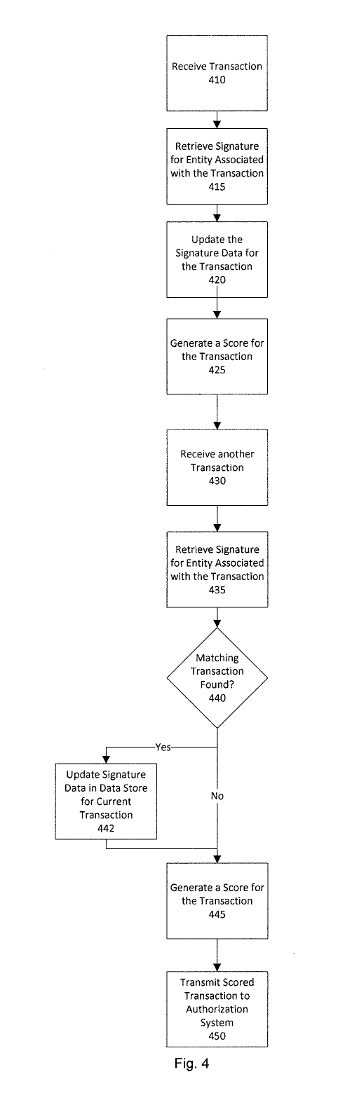

After a period of time, the gas pump 110 receives a response to the second request 345. The response may be an authorization or denial of the request. At this point, the payment processing system 130 has received two requests—the preauthorization and the advice request. If these two requests have both been processed, the customer's account may have been debited for an amount greater than the actual amount. A process for resolving this potential issue is described in relation to FIG. 4 below.

The gas pump 110 next determines whether the authorization request is successful 350. If the authorization request is successful, the gas pump provides feedback to the user. For example, in the embodiment shown, the gas pump 110 displays a message that the transaction was approved 355. In other embodiments, the gas pump 110 or other point-of-sale device may print a receipt, send an email, or otherwise confirm the completion of the transaction.

As with the initial transaction, it the authorization is not successful, the gas pump may request another payment type or another attempt by the customer 360. For instance, if the transaction exceeds the credit limit of the card, the gas pump 110 may request another payment type be used.

FIG. 4 is a flow chart showing an example of a process implemented by the payment processing system 130 upon receiving a first set of transaction data. In the embodiment shown, the payment processing system 130 receives a set of transaction data associated with a transaction 410. The payment processing system 130 illustrated in FIG. 4 includes only one server 140. Server 140 includes software to execute the processes described herein. The transaction may be received in a variety of formats. For example, in one embodiment, server 140 includes software for operating as a web server. In such an embodiment, the transaction may be created on the gas pump 110 as a secure HTTPS form POST and then transmitted to the server 140. The server 140 may be, for example, a bank's server.

The server 140 passes the transaction to the UC 170, which retrieves a signature for entities associated with the transaction data 415. For example, historical purchase data may be retrieved from data store 150. In one example, the historical purchase data includes information associated with the last thirty transactions.

The OSE 180 then updates the signature data for the transaction data 420. This data can then be processed by the OSE 180. Next, the UC 170 and OSE 180 may extract the field/value pairs from the submitted form and determine that the transaction is a preauthorization. The OSE 180 next generates a score for the transaction 425.

The UC 170 next receives another transaction 430. The UC 170 then retrieves the signature associated with the entity that is associated with the transaction 435.

Next, the OSE 180 searches for a transaction in the data store 150 that is related to or otherwise matches the received transaction 440. A matching transaction may, for example, be a transaction in which the account number, merchant number, and date match, but the timestamp and amounts differ. This is merely an example. Many other types of transactions may be determined to match.

If a matching transaction exists, the OSE 180 updates the signature 442. Updating the signature in this way essentially eliminates the prior transaction from the signature. Doing so more accurately reflects the actual transactions that have taken place for a particular customer by eliminating transactions that are recorded, for example, using a transaction amount that is not reflective of the actual, final transaction amount. If the transactions are unrelated, the signature for the entity associated with the first transaction is not updated.

In some cases, the first transaction, and the second matching transaction may be received sequentially. For example, they may be a first and second transaction received during a day. In other cases, the transactions may be received among a plurality of other non-related transactions. The transactions may also be received out of sequence, i.e., the second transaction may be received before the first transaction. However, in such cases, data within the transaction can be used to determine which of the matching transactions contains the actual amount to be stored as part of the signature. For example, the pre-authorization transaction described above may be submitted, and before the advice transaction is submitted, the customer may walk in to a convenience store co-located with the gas pump 110 to make a purchase with the same card. Subsequently, the gas transaction completes. In another example, multiple transactions may be compiled before they are transmitted for processing by the UC 170 and OSE 180.

The OSE 180 next generates a score for the transaction 445. The transaction that is scored may be the transaction as it is received or the updated transaction. Updating the signature in the data store 150 allows the OSE 180 to score the transaction and to later utilize the signature data to perform further processing on the transaction data as described herein. A threshold for the score may be determined and then used for a comparison to determine whether a particular transaction or set of transactions is fraudulent. In some embodiments, the threshold is a pre-determined threshold. If the score is below the threshold, then the transaction may be fraudulent, and the system can generate an indication to the payment processing system 130 or otherwise.

The UC 170 next transmits the scored transaction back to the authorization system 160 for use by the bank 455. For example, after the first transaction, the authorization system 160 may signal the point-of-sale terminal, gas pump 110, to proceed with the transaction.

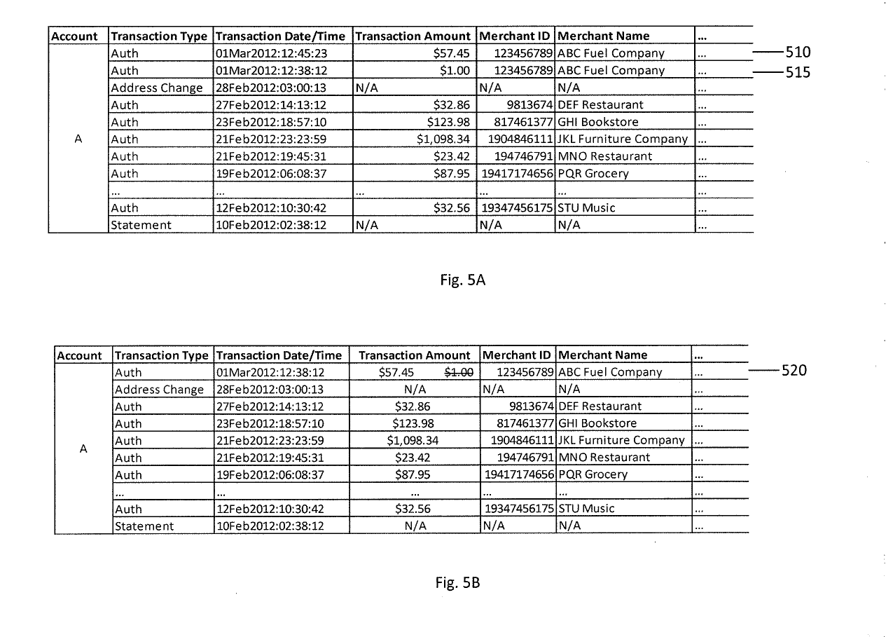

FIGS. 5A and 5B are tables showing an example of data that may be used for the signature with and without implementation of an example process for matching the transactions.

FIG. 5A illustrates the data used for the signature after the two transactions 510, 515 have been inserted into the data store 150 but before the matching process has completed. As illustrated, the first two transactions in the table were received for the same account, from the same merchant, and in a relatively short amount of time. An embodiment can use this raw data as a signature to match those transactions. FIG. 5B illustrates the data used for the signature after matching. The first and second transactions have been matched, eliminating the $1 preauthorization charge from the list of transactions used as part of the signature for the account, leaving only the first transaction with an updated amount and timestamp 520.

The UC 170 and OSE 180 may perform additional functions as well. For example, in the embodiment shown, the server 140 may include software for performing fraud detection. For instance, if a credit card is stolen, a customer may use it to perform an initial authorization and then cancel the transaction. The customer may repeat this process several times with different cards. If the server 140 detects this pattern of activity, the server 140 may determine that fraud is occurring and issue an alert.

Some embodiments may allow for the matching of domain-specific transactions without requiring the point-of-sale system identifies consecutive, related transactions. Further, some embodiments are able to process raw, unprocessed data to identify fraud. For example, some embodiments are capable of determining that multiple preauthorization requests that have occurred are related based on the raw data, for example, the point-of-sale device or merchant associated with the transaction. The system is then able to determine that the pattern is likely fraudulent without requiring additional information form the point-of-sale device. For instance, changes or variances from typical societal use of credit and debit cards in general or changes from a particular card or account's typical behavior may indicate fraudulent behavior.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus.

The computer readable medium can be a machine readable storage device, a machine readable storage substrate, a memory device, a composition of matter effecting a machine readable propagated communication, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code), can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., on or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) to LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any from, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specifics, these should not be construed as limitations on the scope of the invention or of what may be claimed, but rather as descriptions of features specific to particular embodiments of the invention. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

1. A computer-implemented method, comprising:
receiving, on a computing device, transaction data associated with an entity;
retrieving signature data associated with the entity, wherein the signature data includes historic data associated with the entity;
updating the signature data to include the transaction data, wherein updating includes using a model;
generating a score for the transaction data using the updated signature data and the model;
receiving new transaction data associated with the entity;
retrieving the updated signature data;
determining whether the transaction data and the new transaction data are related;
based upon determining that the transaction data and the new transaction data are related, updating the transaction data with the new transaction data; and
generating a score for the updated transaction data using the updated signature data and the model.

2. The method of claim 1, wherein updating the transaction data includes replacing the transaction data with the new transaction data.

3. The method of claim 1, wherein the transaction data and the new transaction data are received sequentially.

4. The method of claim 1, wherein the signature data includes one or more fields, and wherein data in a field is used to generate a model variable.

5. The method of claim 1, wherein the transaction data and the new transaction data include one or more fields, wherein the one or more fields include a time stamp field that is used to determine that the transaction data and the new transaction data are related.

6. The method of claim 1, wherein the transaction data includes one or more fields, and wherein the one or more fields include a credit card identifier field.

7. The method of claim 1, wherein the transaction data is associated with a pre-authorization transaction.

8. The method of claim 1, wherein the new transaction data is associated with an advise transaction.

9. The method of claim 1, further comprising:
storing the retrieved signature data in a data store.

10. The method of claim 1, further comprising:
storing the updated signature data in a data store.

11. The method of claim 1, further comprising:
determining a threshold fraud score;
comparing the updated transaction data score with the threshold fraud score; and
determining that the transaction is fraudulent when the updated transaction data score is below the threshold fraud score.

12. The method of claim 1, wherein retrieving signature data includes retrieving signature data from a data store.

13. The method of claim 1, wherein the transaction data is not updated with the new transaction data when the transaction data and the new transaction data are unrelated.

14. A system, comprising:
one or more processors; and
one or more non-transitory computer-readable storage mediums containing instructions configured to cause the one or more processors to perform operations including:
receiving transaction data associated with an entity;
retrieving signature data associated with the entity, wherein the signature data includes historic data associated with the entity;
updating the signature data to include the transaction data, wherein updating includes using a model;
generating a score for the transaction data using the updated signature data and the model;
receiving new transaction data associated with the entity;
retrieving the updated signature data;
determining whether the transaction data and the new transaction data are related;
based upon determining that the transaction data and the new transaction data are related, updating the transaction data with the new transaction data; and
generating a score for the updated transaction data using the updated signature data and the model.

15. The system of claim 14, wherein the one or more non-transitory computer-readable storage mediums further contain instructions configured to cause the one or more processors to perform operations including:
storing the updated signature data in a data store.

16. The system of claim 14, wherein the one or more non-transitory computer-readable storage mediums further contain instructions configured to cause the one or more processors to perform operations including:
determining a threshold fraud score;
comparing the updated transaction data score with the threshold fraud score; and
determining that the transaction is fraudulent when the updated transaction data score is below the threshold fraud score.

17. A computer-program product, tangibly embodied in a non-transitory machine-readable storage medium, and including instructions configured to cause a data processing system to:
receive transaction data associated with an entity;
retrieve signature data associated with the entity, wherein the signature data includes historic data associated with the entity;
update the signature data to include the transaction data, wherein updating includes using a model;
generate a score for the transaction data using the updated signature data and the model;
receive new transaction data associated with the entity;
retrieve the updated signature data;
determine whether the transaction data and the new transaction data are related;
update the transaction data with the new transaction data, wherein updating is based upon a determination that the transaction data and the new transaction data are related; and
generate a score for the updated transaction data using the updated signature data and the model.

18. The computer-program product of claim 17, further including instructions configured to cause the data processing system to:
store the updated signature data in a data store.

19. The computer-program product of claim 17, further including instructions configured to cause the data processing system to:
determine a threshold fraud score;
compare the updated transaction data score with the threshold fraud score; and
determine that the transaction is fraudulent when the updated transaction data score is below the threshold fraud score.
